(19) United States
(12) Patent Application Publication
(10) Pub. No.: US 2025/0164147 A1
(43) Pub. Date: May 22, 2025

(54) INSTANT ELECTRIC HEATER FOR A FLUID AND METHOD FOR THE CONTROL THEREOF

(71) Applicant: DE' LONGHI APPLIANCES S.r.l., Treviso (IT)

(72) Inventors: Giovanni ROSSETTO, Treviso (IT); Roberto SANSON, Treviso (IT)

(73) Assignee: DE' LONGHI APPLIANCES S.r.l., Treviso (IT)

(21) Appl. No.: 18/729,068

(22) PCT Filed: Jan. 17, 2023
(86) PCT No.: PCT/EP2023/050955

§ 371 Date: Jul. 15, 2024

(30) Foreign Application Priority Data
Jan. 28, 2022 (IT) 102022000001502

(51) Int. Cl. F24H 1/14; A47J 31/56; F24H 9/00; F24H 15/212; H05B 3/46

(52) U.S. Cl. CPC F24H 1/142; A47J 31/56; F24H 9/0015; F24H 15/212; H05B 3/46; F24H 2250/02; H05B 2203/003; H05B 2203/005; H05B 2203/013

(57) ABSTRACT

The instant electric heater for a fluid comprises an axial metal tube, electric resistive means positioned on an outer surface of the metal tube, an inlet manifold body and an outlet manifold body positioned at the ends of the metal tube, a screw positioned along an internal axial cavity of the metal tube and having a thread delimiting, with an inner surface of the metal tube, a helical channel for conveying the fluid from the inlet manifold body to the outlet manifold body, temperature sensor means for sensing the temperature of the fluid, and an outer casing for the protection of the metal tube, the electric resistive means comprising at least a first electric heating element and a second electric heating element that can be independently powered.

### CROSS-REFERENCE TO RELATED APPLICATIONS

This is a U.S. National Phase Application under 35 U.S.C. 371 of International Patent Application No. PCT/EP2023/050955, filed Jan. 17, 2023, which claims benefit of priority to Italian Patent Application No. 102022000001502, filed Jan. 28, 2022. The entire contents of these applications are hereby incorporated by reference.

### FIELD OF THE INVENTION

The present invention relates to an instant electric heater for a fluid and a method for the control thereof.

### BACKGROUND

There are known instant electric heaters of the type comprising a metal tube, a thick film electric heating element positioned on the outer surface of the metal tube, a screw positioned along an internal cavity of the metal tube and having a thread delimiting, with the inner surface of the metal tube, a helical channel for conveying the fluid between an inlet manifold body and an outlet manifold body applied to close the ends of the metal tube.

Generally, such electric heaters comprise a temperature sensor for controlling the fluid temperature, positioned in one of the manifold bodies.

Instant electric heaters of this type are used in the most common applications solely to rapidly heat water, without the latter undergoing a pressure increase.

These instant electric heaters are thus generally used for considerable flows, for example in the heating of water for sanitary use or for the preparation of beverages such as tea.

Such instant electric heaters provide an imprecise control of the temperature if they are used to produce beverages, such as, for example, coffee, which require a fluid under pressure with a low flow rate.

### SUMMARY

The technical task of the invention is to provide an instant electric heater of the type described above that can show a greater versatility of use in providing a precise temperature regulation also for fluids delivered under pressure and at a low flow rate.

Within the scope of this technical task, one object of the invention is to provide an instant electric heater of the above-described type that can provide a precise temperature regulation with an optimization of energy efficiency.

Another object of the invention is to provide an instant electric heater of the above-described type that ensures the repeatability of the results.

Another object of the invention is to provide an instant electric heater of the above-described type that ensures repeatability also at a mass production level.

The technical task, as well as this and other objects, are achieved by the present invention, which discloses an instant electric heater for a fluid, comprising an axial metal tube, electric resistive means positioned on an outer surface of the metal tube, an inlet manifold body and an outlet manifold body positioned at the ends of said metal tube, a screw positioned along an internal axial cavity of the metal tube and having a thread delimiting, with an inner surface of the metal tube, a helical channel for conveying the fluid from said inlet manifold body to said outlet manifold body, temperature sensor means for sensing the temperature of said fluid, and an outer casing for the protection of said metal tube, characterized in that said electric resistive means comprise at least a first and a second electric heating element that can be independently powered.

Advantageously, said electric resistive means can be of the thick film type.

In one embodiment of the invention, said first and second electric heating elements have a serpentine configuration, with turns of said first electric heating element alternating with turns of said second electric heating element.

Advantageously, said temperature sensor means comprise at least a first temperature sensor applied on said outer surface of said metal tube.

Advantageously, the electric heater comprises a constrained angular orientation means between said metal tube and said screw around the axis of said metal tube.

Advantageously, said constrained angular orientation means is configured to offset, in the direction of the axis of the metal tube, the position of said first temperature sensor relative to the crest of the thread of said screw.

In one embodiment of the invention, said metal tube engages with at least one of said manifold bodies and said constrained angular orientation means comprises a first engagement means with constrained angular orientation between said screw and said at least one of said manifold bodies.

In one embodiment of the invention, said constrained angular orientation means comprises a second engagement means with constrained angular orientation between said at least one of said manifold bodies and said casing.

In one embodiment of the invention said temperature sensor means comprise at least a second temperature sensor positioned inside one of said manifold bodies.

In one embodiment of the invention, there are provided fluid-tight connecting gaskets between the ends of the metal tube and said manifold bodies.

The present invention also discloses a method for controlling said instant electric heater, wherein a heating cycle is carried out by powering only one or both of the electric heating elements.

Advantageously, the power supply to one of the two electric heating elements can be modulated.

### BRIEF DESCRIPTION OF THE DRAWINGS

Further features and advantages of the invention will more fully emerge from the description of a preferred, but not exclusive, embodiment thereof, of the instant electric heater according to the invention by way of non-limiting example in the drawings, in which:

FIG. 1 shows a side elevation view of the instant electric heater;

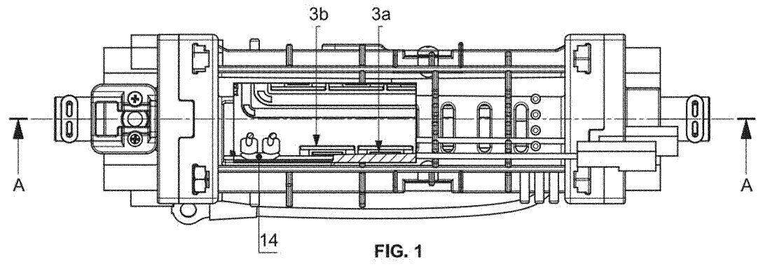

FIG. 1a shows an axial sectional view of the instant electric heater along the line A-A in FIG. 1;

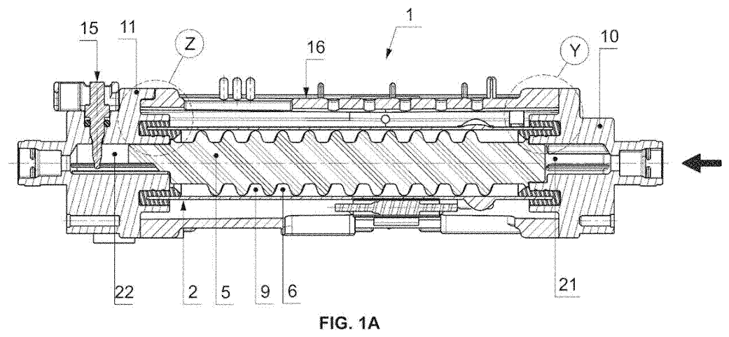

FIG. 2 shows an axonometric view of the metal tube bearing the resistive means and the first temperature sensor;

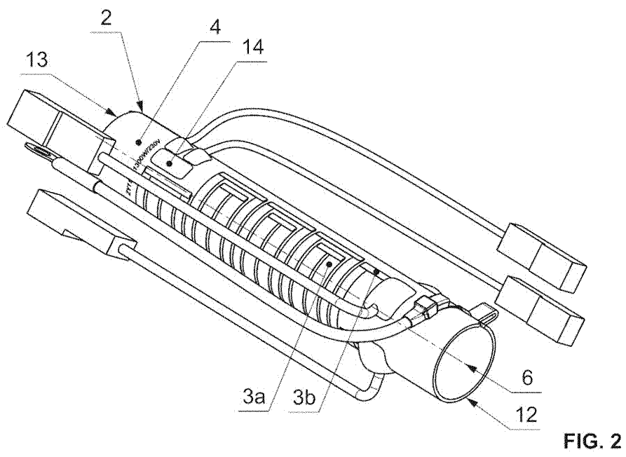

FIG. 3 shows a detail of the instant electric heater wherein the constrained angular positioning means between the thread of the screw and the first temperature sensor is evident;

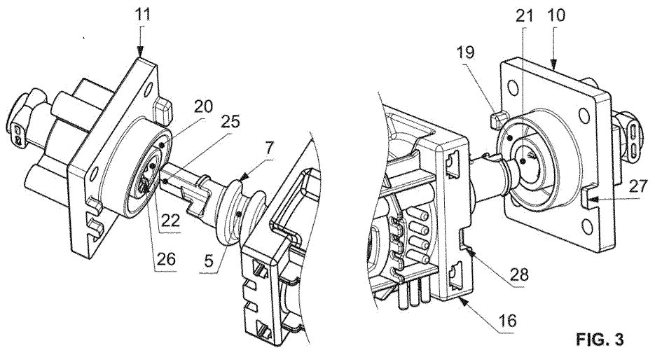

FIG. 4 shows a detail of the positioning between the thread of the screw and the first temperature sensor;

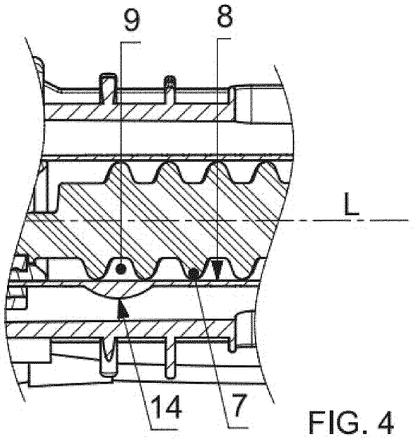

FIG. 5 shows the detail Y of FIG. 1a;

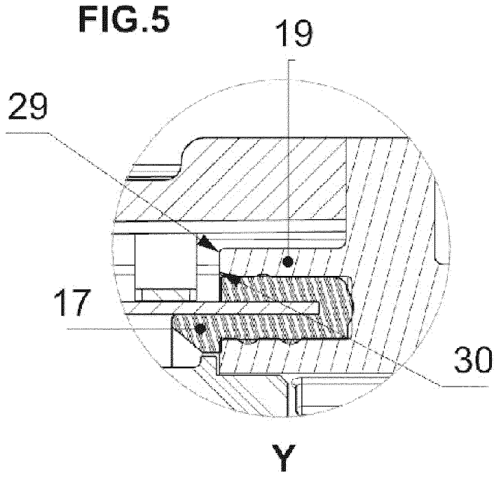

FIG. 6 shows the detail Z of FIG. 1a; and

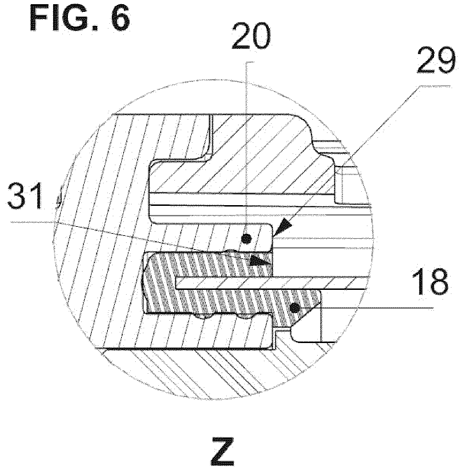

FIG. 7 shows the axially sectioned annular gasket in detail.

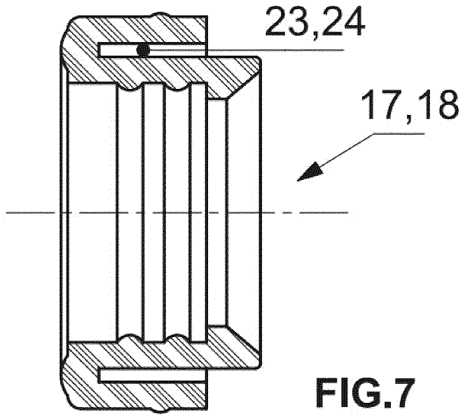

### DETAILED DESCRIPTION

With reference to the figures, the electric heater for a fluid, generically denoted by the reference 1, is of the instant- or in jargon “through flow”-type.

The heater 1 comprises a tube 2 made of a heat conducting material, typically metal, for example steel, that extends along an axis L and has an outer surface 4 that is in particular cylindrical in shape and an inner surface 8 that is also in particular cylindrical in shape.

Suitable electric resistive means 3a, 3b are positioned on the outer surface 4 of the metal tube 2. A screw 5, suitably positioned along an internal axial cavity 6 of the metal tube 2, has a thread 7 delimiting, with the inner surface 8 of the metal tube 2, a helical channel 9 for conveying the fluid from an inlet manifold body 10 for the fluid to be heated to an outlet manifold body 11 for the heated fluid, applied to close off respective ends 12 and 13 of the metal tube 2.

Special gaskets 17, 18 connect, in a fluid tight manner, each of the ends 12, 13 of the metal tube 2 and the corresponding manifold body 10, 11.

In particular, each manifold body 10, 11 comprises an annular housing 19, 20 that surrounds an axial channel 21, 22 that connects the ends of the helical channel 9 for conveying the fluid outside the heater 1.

The axial channel 21, 22 is coaxial with the screw 5 and with the metal tube 2.

The annular housing 19, 20 accommodates the gasket 17, 18, which has a corresponding annular shape.

The annular gasket 17, 18 in turn has an annular recess 23, 24 which receives the ends of the metal tube 2.

The heater 1 also has special sensor means 14, 15 for sensing the temperature of the fluid, and an outer casing 16 for the protection of the metal tube 2.

The outer casing 16 is rigidly fixed to the metal tube 2 and engages at its opposite ends with a respective manifold body 10, 11.

According to a salient aspect of the invention, the electric resistive means 3a, 3b comprise at least a first electric heating element 3a and a second electric heating element 3b that can be independently powered.

The resistive means 3a, 3b are of the thick film type and in particular, therefore, they are formed from an electrically conductive paste screen printed on the outer surface 4 of the metal tube 2.

The first electric heating element 3a and the second electric heating element 3b have serpentine configuration, with turns of the first heating element 3a alternating with turns of the second heating element 3b.

The resistive means 3a, 3b extend at least for most of the length of the metal tube and cover at least most of the outer circumference of the metal tube 2.

The temperature sensor means 14, 15 comprise at least a first temperature sensor 14, for example an NTC sensor, applied on the outer surface 8 of the metal tube 2.

Advantageously, a constrained angular orientation means is provided between the metal tube 2 and the screw 5 around the axis L of the metal tube 2.

The constrained angular orientation means is configured to offset, along the direction of the axis of the axis L of the metal tube 2, the position of the first temperature sensor 14 relative to the crest of the thread 7 of the screw 5.

In this manner, the area of the metal tube 2 covered by the first sensor 14 is in direct contact with the fluid to be heated and the measurement of the temperature of the fluid to be heated can be much more precise.

The constrained angular orientation means comprises a first engagement means with constrained angular orientation between the screw 5 and at least one of the manifold bodies 10, 11, for example the manifold body 10.

The first engagement means with constrained angular orientation comprises a shaped axial extension 25 of the screw 5 which extends inside the axial channel 22 of the manifold body 11 and a corresponding axial engagement seat 26 delimited by special partitions extending from the inner surface of the axial channel 22 of the manifold body 11.

The first engagement means brings about a constraint between the screw 5 and the manifold body 11, which is rigid relative to the rotation around the axis L.

The constrained angular orientation means comprises a second engagement means with constrained angular orientation between at least one of the manifold bodies 10, 11 and the casing 16, in particular the same manifold body 11 that has constrained angular orientation relative to the screw 5.

The second engagement means with constrained angular orientation comprises protrusions 27 that extend orthogonally from the face of the manifold body 10 turned towards the casing 16 and corresponding engagement seats 28 provided in the casing 16.

In order to stiffen the structure of the heater 1, there can be provided screws that fasten the manifold bodies 10, 11 against the ends of the casing 16.

The axial center of screw 5 in the metal tube 2 is assured by the presence of two internal shoulders 29 in the manifold bodies 10 and 11 which act on the shoulders 30 and 31 present in the screw 5.

The shoulders 30 and 31 and the first constrained angular positioning means are obviously configured in such a way as to allow the free circulation of the fluid that reaches the outlet channel 22 from the inlet channel 21 by passing through the helical channel 9.

It should be noted that the constrained angular positioning means between the screw 5 and the metal tube 2 can be provided either by the inlet manifold body 10, as shown, or by the outlet manifold body 11, or else by both.

For even better control of the fluid temperature, the temperature sensor means 14, 15 comprise at least a second temperature sensor 15 positioned inside one of the manifold bodies 10, 11, in this specific case in the manifold body 11.

It should be noted that the position of the second temperature sensor can be provided either in the inlet manifold body 10 or in the outlet manifold body 11.

The control method of the instant electric heater 1 envisages that, according to the application, the heating cycle can be carried out with the first electric heating element 3a powered and the second electric heating element 3b not powered or with both electric heating elements 3a, 3b powered.

The power supply to each electric heating element in turn can be modulated so as to control the overall power delivered.

For the preparation of a hot beverage, the fluid to be heated, in particular water, is supplied by a pump to the axial channel 21 of the inlet manifold body 10.

The water circulates through the helical channel 9, where it is heated by the electric resistive means 3a, 3b before being delivered to the outside by means of the axial channel 22 of the outlet manifold body 11.

The electric resistive means 3a, 3b comprise a first electric heating element 3a and a second electric heating element 3b, precisely in order to improve precision in temperature regulation both for low fluid flow rates, such as for example envisaged for the preparation of expresso coffee, and for higher fluid rates, as is envisaged for example for the preparation of tea.

In this manner, electricity is used in an optimal manner also based on the necessary flow.

In particular, in a brewing cycle for the preparation of coffee, only one of the two electric heating elements 3a, 3b will be powered, whereas in a brewing cycle for the preparation of tea, both of the electric heating elements 3a, 3b will be powered.

1. An instant electric heater for a fluid, comprising an axial metal tube, one or more electric resistive heating elements positioned on an outer surface of the metal tube, an inlet manifold body and an outlet manifold body positioned at the ends of said metal tube, a screw positioned along an internal axial cavity of the metal tube and having a thread delimiting, with an inner surface of the metal tube, a helical channel for conveying the fluid from said inlet manifold body to said outlet manifold, one or more temperature sensors for sensing the temperature of said fluid, and an outer casing for the protection of said metal tube, wherein said one or more electric resistive heating elements comprise at least a first electric heating element and a second electric heating element that can be independently powered.

2. The instant electric heater according to claim 1, wherein said one or more electric resistive heating elements are of a thick film type.

3. The instant electric heater according to claim 1, wherein said first and second electric resistive heating elements have a serpentine configuration, with turns of said first electric heating element alternating with turns of said second electric heating element.

4. The instant electric heater according to claim 1, wherein said one or more temperature sensors comprise at least a first temperature sensor positioned on said outer surface of said metal tube.

5. The instant electric heater according to claim 4, further comprising a constrained angular orientation means between said metal tube and said screw around an axis of said metal tube.

6. The instant electric heater according to claim 5, wherein said constrained angular orientation means is configured to offset, in the direction of the axis of the metal tube, the position of said first temperature sensor relative to a crest of the thread of said screw.

7. The instant electric heater according to claim 5, wherein said metal tube engages with at least one of said manifold bodies and said constrained angular orientation means comprises a first engagement means with constrained angular orientation between said screw and said at least one of said manifold bodies.

8. The instant electric heater according to claim 7, wherein said constrained angular orientation means comprises a second engagement means with constrained angular orientation between said at least one of said manifold bodies and said casing.

9. The instant electric heater according to claim 4, wherein said one or more temperature sensors comprise at least a second temperature sensor positioned inside one of said manifold bodies.

10. The instant electric heater according to claim 1, further comprising fluid-tight connecting gaskets between the ends of the metal tube and said manifold bodies.

11. A method for controlling an instant electric heater for a fluid according to claim 1, wherein a heating cycle is carried out by powering only one or both of the electric resistive heating elements.

12. The method for controlling an instant electric heater for a fluid according to claim 12, wherein a power supply to one of the two electric resistive heating elements is modulated.
